(19) United States
(12) Patent Application Publication
(10) Pub. No.: US 2013/0201328 A1
(43) Pub. Date: Aug. 8, 2013

(54) MULTIMEDIA PROCESSING AS A SERVICE

(71) Applicant: Hing Ping Michael CHUNG, Gaithersburg, MD (US)

(72) Inventor: Hing Ping Michael CHUNG, Gaithersburg, MD (US)

(21) Appl. No.: 13/369,077

(22) Filed: Feb. 8, 2012

(51) Int. Cl. H04N 7/18

(52) U.S. Cl. CPC H04N 7/183
USPC 348/143

(57) ABSTRACT

Systems are provided for receiving the video data from the camera. In one embodiment, a system is provided to compare, for all frames of the video, one frame with another frame of the video data, to determine if there are dynamic objects between the two frames, wherein the determination is based on movements of corresponding pixels between the two frames; filtering out the dynamic objects in each frame; applying special effects to highlight the dynamic objects by coloring the dynamic objects in each frame; applying special effects to grey out static objects, or the non-dynamic objects, by coloring the static objects in each frame where the dynamic objects are found.

### FIELD OF THE INVENTION

This invention generally relates to video processing system. Specifically, but not limited to, this invention relates to real-time network-based video processing systems for detecting and modifying particular objects of a video stream.

### BACKGROUND OF THE INVENTION

Image processing has been known for years. Video processing, however, is gaining popularity and many have viewed that it will become the future of the industry of information technology. Video capture technology has been used in many areas. For example, video processing is already been used extensively in security checking in virtually every building where security is concerned, such as hospitals, police stations, and airports. In most instances, some of these videos are captured continuously. The challenge is, there are hardly any technologies that can highlight certain parts of a video where those parts may be of special importance. For example, in a video captured in an airport, bags of certain size, shape, and color are always watched by airport security guards, as such information may provide hints that dangerous items may be found. As a result, in cases where such objects are found in a video, there should be mechanism to alert the airport authority.

### SUMMARY OF THE INVENTION

Consistent with embodiments of the invention, a real-time network-based video processing system for detecting and modifying particular objects of a video stream is provided. In one embodiment, the exemplary system may include a camera, which is configured to perform a series of steps, including receiving, from a user, a selection that indicates a mode of operations; receiving video images, in form of frames; receiving instructions with respect to the mode of operations selected; and sending video data to video systems for image processing through a wireless network.

The system may further include a mobile device including a video display, wherein the mobile device is configured to receive streaming videos; and display streaming videos. Further, a processor and a memory may be included in the system. The memory may contain steps including receiving the video data from the camera; comparing a first frame with a second frame of the video data, to determine if there are moving objects between the two frames, wherein the determination is based on movements of corresponding pixels between the first and second frames; filtering out the moving objects in the first and second frames; applying a first special effect to the moving objects by coloring the moving objects in the first and second frames; applying a second special effect to static objects, or the non-moving objects, by coloring the static objects in the first and second frames; to compose new video data, re-combining, frame by frame, the moving objects with the static objects, after the first and second special effects being applied to the first and second frames; and sending the new video data, as video stream, to the mobile device through the wireless network to display the new video data.

In another embodiment, the determination if there are any moving objects may be based on movements of corresponding pixels between the first and second frames. After filtering out the moving objects in the first and second frames, the system may support allowing the user to select a moving object from the moving objects; applying a first special effect to the selected moving object by coloring the selected moving object in the first and second frames; applying a second special effect to unselected moving objects and static objects, or the non-moving objects, by coloring the unselected moving objects and the static objects in the first and second frames; to compose new video data, re-combining, frame by frame, the selected moving objects, the unselected moving objects, and the static objects, after the first and second special effects being applied to the first and second frames; and sending the new video data, as video stream, to the mobile device through the wireless network to display the new video data.

In another embodiment, before composing new video data, the system may be configured to allow applying a first special effect to highlight the selected moving object by coloring the selected moving object in the first and second frames; applying a second special effect to grey-out unselected moving objects and static objects, or the non-moving objects, by coloring the unselected moving objects and the static objects in the first and second frames; to compose new video data, re-combining, frame by frame, the selected moving objects, the unselected moving objects, and the static objects, after the first and second special effects being applied to the first and second frames; and sending the new video data, as video stream, to the mobile device through the wireless network to display the new video data.

### BRIEF DESCRIPTION OF THE DRAWINGS

FIG. 1 illustrates an exemplary video processing system illustrating a frame before applying special effects, consistent with embodiments of the present invention.

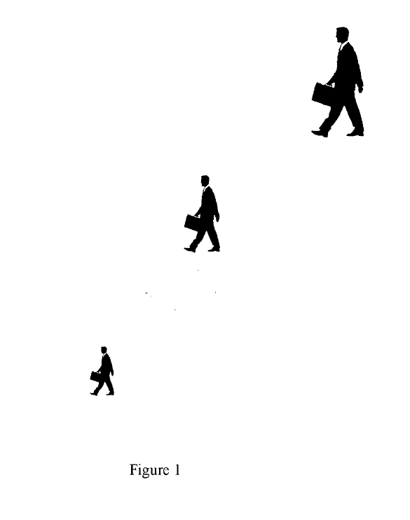

FIG. 2 illustrates an exemplary police training system illustrating a frame after special effects are applied, consistent with embodiments of the present invention.

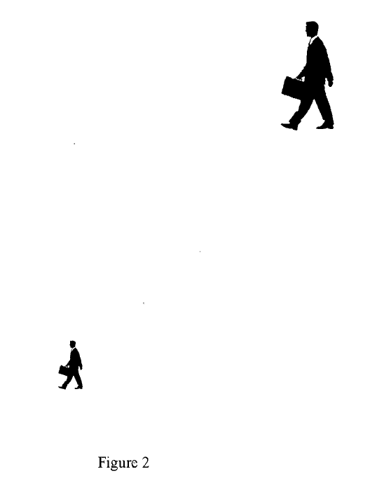

### DETAILED DESCRIPTION

A real-time network-based video processing system for detecting and modifying particular objects of a video stream without needing to store any uploaded content is disclosed. In this exemplary system, a camera is included, which is configured to perform a series of steps, comprising: receiving, from a user, a selection that indicates a mode of operations; receiving video images, in form of frames; receiving instructions with respect to the mode of operations selected; and sending video data to video systems for image processing through wireless networks. The system includes a mobile device including a video display, wherein the mobile device is configured to receive streaming videos; display streaming videos. Included in the system is a wireless network; and a video processing system including a processor and a memory storing instructions to cause the processor to execute a method, wherein the method comprises: receiving the video data from the camera, avoiding delay for waiting for entire video to be completed; comparing, for all frames of the video, one frame with another frame of the video data, to determine if there are dynamic objects between the two frames, wherein the determination is based on movements of corresponding pixels between the two frames; filtering out the dynamic objects in each frame; applying special effects to highlight the dynamic objects by coloring the dynamic objects in each frame; applying special effects to grey out static objects, or the non-dynamic objects, by coloring the static objects in each frame; to compose new video data, re-combining, frame by frame, the dynamic objects with the static objects, after the special effects be applied; sending the new video data, as video stream, to the mobile device through the wireless network for displaying the new video data; erasing the received video data, to avoid liability of copyright infringement; and erasing the sent new video data, to avoid liability of copyright infringement.

In another system the method may be implemented that includes receiving the video data from the camera; receiving the photographic image from the camera; comparing, for all frames of the video, one frame of the video with the image captured by the camera, to determine if user-defined dynamic objects are found in each frame, wherein the determination is based on both similarity of pixels and movements of corresponding pixels between the frame and the image; filtering out the user-defined dynamic objects in each frame; applying special effects to highlight the user-defined dynamic objects by coloring the user-defined dynamic objects in each frame; applying special effects to grey out static objects and the non-user-defined dynamic objects, by coloring the static objects and the non-user-defined dynamic objects in each frame; to compose new video data, re-combining, frame by frame, the user-defined dynamic objects, non-user-defined dynamic objects, and the static objects, after the special effects be applied; sending the new video data, as video stream, to the mobile device through the wireless network for displaying the new video data; erasing the received video data and received image, to avoid liability of copyright infringement; and erasing the sent new video data, to avoid liability of copyright infringement.

Alternatively, for each frame of the video, comparison may be made between frames. One frame of the video data may be compared with a certain number of consecutive frames of the video data, to determine if user-defined dynamic objects are found in each frame, wherein the determination is based on the similarity of pixels and movements of corresponding pixels between the one frame and the consecutive frames of the video data, in view of the criteria, including: a time period defined by the user allowing the user-defined dynamic objects to be found in a given frame; space defined by user allowing the user-defined dynamic objects to be found in a certain area within a given frame; color change allowing the user-defined dynamic objects to be found only if certain objects undergo certain color change; background color change due to weather allowing certain user-defined dynamic objects to be ignored if those certain objects undergo certain color change merely due to background color change, including weather change of a background; speed of movement defined by the user allowing the user-defined dynamic objects to be found in a given frame only when the objects move at a certain speed; sound defined by the user allowing the user-defined dynamic objects to be found in a given frame only when the objects move with certain characteristics of sound that is found in an associated frame; and frequency of movements defined by the user allowing the user-defined dynamic objects to be found in a given frame only when the objects move at a certain frequency; filtering out the user-defined dynamic objects in each frame, in view of the criteria; applying special effects to highlight the user-defined dynamic objects by coloring the user-defined dynamic objects in each frame; applying special effects to grey out static objects and the non-user-defined dynamic objects, by coloring the static objects and the non-user-defined dynamic objects in each frame; to compose new video data, re-combining, frame by frame, the user-defined dynamic objects, non-user-defined dynamic objects, and the static objects, after the special effects be applied; sending the new video data, as video stream, to the mobile device through the wireless network for displaying the new video data; erasing the received video data and received image, to avoid liability of copyright infringement; and erasing the sent new video data, to avoid liability of copyright infringement.

Further in the system, special effects may be applied to highlight static objects, or the non-dynamic objects, by coloring the static objects in each frame; to compose new video data, re-combining, frame by frame, only the static objects, after the special effects be applied; sending the new video data only the static objects incorporating the special effects, as video stream, to the mobile device through the wireless network for displaying the new video data; erasing the received video data, to avoid liability of copyright infringement; and erasing the sent new video data, to avoid liability of copyright infringement.

To determine if user-defined dynamic objects are found in each frame, similarity of pixels and movements of corresponding pixels can be made between the one frame and the consecutive frames of the video data, in view of the following criteria, including: a time period defined by the user allowing the user-defined dynamic objects to be found in a given frame; space defined by user allowing the user-defined dynamic objects to be found in a certain area within a given frame; color change allowing the user-defined dynamic objects to be found only if certain objects undergo certain color change; background color change due to weather allowing certain user-defined dynamic objects to be ignored if those certain objects undergo certain color change merely due to background color change, including weather change of a background; speed of movement defined by the user allowing the user-defined dynamic objects to be found in a given frame only when the objects move at a certain speed; sound defined by the user allowing the user-defined dynamic objects to be found in a given frame only when the objects move with certain characteristics of sound that is found in an associated frame; and frequency of movements defined by the user allowing the user-defined dynamic objects to be found in a given frame only when the objects move at a certain frequency; filtering out the user-defined dynamic objects in each frame, in view of the criteria; applying special effects to highlight the user-defined dynamic objects by coloring the user-defined dynamic objects in each frame; to safe bandwidth, composing new video data, only by re-combining, frame by frame, the user-defined dynamic objects while ignoring the non-user-defined dynamic objects and the static objects; sending the new video data, as video stream, to the mobile device through the wireless network for displaying the new video data; erasing the received video data and received image, to avoid liability of copyright infringement; and erasing the sent new video data, to avoid liability of copyright infringement.

In yet another implementation, a determination can be made to deicde if there are faces of individuals in each of the frame of the video data, based on a set of matching criteria, including: shape and size of nose; shape, size, color, of eye; and shape and size of cheek bone; for each determined face, associating each of the face as a dynamic object; filtering out all of the dynamic objects in each frame; applying special effects to highlight the dynamic objects by coloring the dynamic objects in each frame; applying special effects to grey out static objects, or the non-dynamic objects, by coloring the static objects in each frame; to compose new video data, re-combining, frame by frame, the dynamic objects with the static objects, after the special effects be applied; sending the new video data, as video stream, to the mobile device through the wireless network for displaying the new video data.

Although illustrative embodiments have been described herein with reference to the accompanying drawings, it is noted that the invention is not limited to the precise system and method embodiments described herein, and that various other changes and modifications may be affected by one skilled in the art without departing from the scope or spirit of the invention. All such changes and modifications are intended to be included within the scope of the invention as defined by the appended claims.

What is claimed is:

1. A real-time network-based video processing system for detecting and modifying particular objects of a video stream, comprising:
a camera configured to perform a series of steps, comprising:
receiving, from a user, a selection that indicates a mode of operations;
receiving video images, in form of frames;
receiving instructions with respect to the mode of operations selected; and
sending video data to video systems for image processing through a wireless network;
a mobile device including a video display, wherein the mobile device is configured to
receive streaming videos; and
display streaming videos;
a processor; and
a memory storing instructions to cause the processor to execute a method.

2. The system of claim 1, wherein the method comprises:
receiving the video data from the camera;
comparing a first frame with a second frame of the video data, to determine if there are moving objects between the two frames, wherein the determination is based on movements of corresponding pixels between the first and second frames;
filtering out the moving objects in the first and second frames;
applying a first special effect to the moving objects by coloring the moving objects in the first and second frames;
applying a second special effect to static objects, or the non-moving objects, by coloring the static objects in the first and second frames;
to compose new video data, re-combining, frame by frame, the moving objects with the static objects, after the first and second special effects being applied to the first and second frames; and
sending the new video data, as video stream, to the mobile device through the wireless network to display the new video data.

3. The system of claim 1, wherein the method comprises:
receiving the video data from the camera;
comparing a first frame with a second frame of the video data, to determine if there are moving objects between the two frames, wherein the determination is based on movements of corresponding pixels between the first and second frames;
filtering out the moving objects in the first and second frames;
allowing the user to select a moving object from the moving objects;
applying a first special effect to the selected moving object by coloring the selected moving object in the first and second frames;
applying a second special effect to unselected moving objects and static objects, or the non-moving objects, by coloring the unselected moving objects and the static objects in the first and second frames;
to compose new video data, re-combining, frame by frame, the selected moving objects, the unselected moving objects, and the static objects, after the first and second special effects being applied to the first and second frames; and
sending the new video data, as video stream, to the mobile device through the wireless network to display the new video data.

4. The system of claim 1, wherein the method comprises:
receiving the video data from the camera;
comparing a first frame with a second frame of the video data, to determine if there are moving objects between the two frames, wherein the determination is based on movements of corresponding pixels between the first and second frames;
filtering out the moving objects in the first and second frames;
allowing the user to select a moving object from the moving objects;
applying a first special effect to highlight the selected moving object by coloring the selected moving object in the first and second frames;
applying a second special effect to grey-out unselected moving objects and static objects, or the non-moving objects, by coloring the unselected moving objects and the static objects in the first and second frames;
to compose new video data, re-combining, frame by frame, the selected moving objects, the unselected moving objects, and the static objects, after the first and second special effects being applied to the first and second frames; and
sending the new video data, as video stream, to the mobile device through the wireless network to display the new video data.

5. A real-time network-based video processing system for detecting and modifying particular objects of a video stream without needing to store any uploaded content, comprising:
a camera configured to perform a series of steps, comprising:
receiving, from a user, a selection that indicates a mode of operations;
receiving video images, in form of frames;
receiving instructions with respect to the mode of operations selected; and
sending video data to video systems for image processing through wireless networks;
a mobile device including a video display, wherein the mobile device is configured to
receive streaming videos;
display streaming videos;
a wireless network; and
a video processing system including a processor and a memory storing instructions to cause the processor to execute a method.

6. The system of claim 1, wherein the method comprises:
receiving the video data from the camera;
receiving the photographic image from the camera;
comparing, for all frames of the video, one frame of the video with the image captured by the camera, to determine if user-defined dynamic objects are found in each frame, wherein the determination is based on both similarity of pixels and movements of corresponding pixels between the frame and the image;
filtering out the user-defined dynamic objects in each frame;
applying special effects to highlight the user-defined dynamic objects by coloring the user-defined dynamic objects in each frame;
applying special effects to grey out static objects and the non-user-defined dynamic objects, by coloring the static objects and the non-user-defined dynamic objects in each frame;
to compose new video data, re-combining, frame by frame, the user-defined dynamic objects, non-user-defined dynamic objects, and the static objects, after the special effects be applied;
sending the new video data, as video stream, to the mobile device through the wireless network for displaying the new video data;
erasing the received video data and received image, to avoid liability of copyright infringement; and
erasing the sent new video data, to avoid liability of copyright infringement.

7. The system of claim 1, wherein the method comprises:
receiving the video data from the camera;
receiving the instructions from the camera;
comparing, for each frame of the video, one frame of the video data with a certain number of consecutive frames of the video data, to determine if user-defined dynamic objects are found in each frame, wherein the determination is based on the similarity of pixels and movements of corresponding pixels between the one frame and the consecutive frames of the video data, in view of the criteria, including:
a time period defined by the user allowing the user-defined dynamic objects to be found in a given frame;
space defined by user allowing the user-defined dynamic objects to be found in a certain area within a given frame;
color change allowing the user-defined dynamic objects to be found only if certain objects undergo certain color change;
background color change due to weather allowing certain user-defined dynamic objects to be ignored if those certain objects undergo certain color change merely due to background color change, including weather change of a background;
speed of movement defined by the user allowing the user-defined dynamic objects to be found in a given frame only when the objects move at a certain speed;
sound defined by the user allowing the user-defined dynamic objects to be found in a given frame only when the objects move with certain characteristics of sound that is found in an associated frame; and
frequency of movements defined by the user allowing the user-defined dynamic objects to be found in a given frame only when the objects move at a certain frequency;
filtering out the user-defined dynamic objects in each frame, in view of the criteria;
applying special effects to highlight the user-defined dynamic objects by coloring the user-defined dynamic objects in each frame;
applying special effects to grey out static objects and the non-user-defined dynamic objects, by coloring the static objects and the non-user-defined dynamic objects in each frame;
to compose new video data, re-combining, frame by frame, the user-defined dynamic objects, non-user-defined dynamic objects, and the static objects, after the special effects be applied;
sending the new video data, as video stream, to the mobile device through the wireless network for displaying the new video data;
erasing the received video data and received image, to avoid liability of copyright infringement; and
erasing the sent new video data, to avoid liability of copyright infringement.

8. The system of claim 1, wherein the method comprises:
receiving the video data from the camera;
comparing, for all frames of the video, one frame with another frame of the video data, to determine if there are dynamic objects between the two frames, wherein the determination is based on movements of corresponding pixels between the two frames;
filtering out the dynamic objects in each frame;
applying special effects to highlight static objects, or the non-dynamic objects, by coloring the static objects in each frame;
to compose new video data, re-combining, frame by frame, only the static objects, after the special effects be applied;
sending the new video data only the static objects incorporating the special effects, as video stream, to the mobile device through the wireless network for displaying the new video data;
erasing the received video data, to avoid liability of copyright infringement; and
erasing the sent new video data, to avoid liability of copyright infringement.

9. The system of claim 1, wherein the method comprises:
receiving the video data from the camera;
receiving the instructions from the camera;
comparing, for each frame of the video, one frame of the video data with a certain number of consecutive frames of the video data, to determine if user-defined dynamic objects are found in each frame, wherein the determination is based on the similarity of pixels and movements of corresponding pixels between the one frame and the consecutive frames of the video data, in view of the criteria, including:
a time period defined by the user allowing the user-defined dynamic objects to be found in a given frame;
space defined by user allowing the user-defined dynamic objects to be found in a certain area within a given frame;
color change allowing the user-defined dynamic objects to be found only if certain objects undergo certain color change;
background color change due to weather allowing certain user-defined dynamic objects to be ignored if those certain objects undergo certain color change merely due to background color change, including weather change of a background;
speed of movement defined by the user allowing the user-defined dynamic objects to be found in a given frame only when the objects move at a certain speed;
sound defined by the user allowing the user-defined dynamic objects to be found in a given frame only when the objects move with certain characteristics of sound that is found in an associated frame; and
frequency of movements defined by the user allowing the user-defined dynamic objects to be found in a given frame only when the objects move at a certain frequency;
filtering out the user-defined dynamic objects in each frame, in view of the criteria;
applying special effects to highlight the user-defined dynamic objects by coloring the user-defined dynamic objects in each frame;
to safe bandwidth, composing new video data, only by re-combining, frame by frame, the user-defined dynamic objects while ignoring the non-user-defined dynamic objects and the static objects;
sending the new video data, as video stream, to the mobile device through the wireless network for displaying the new video data;
erasing the received video data and received image, to avoid liability of copyright infringement; and
erasing the sent new video data, to avoid liability of copyright infringement.

10. The system of claim 1, wherein the method comprises:
receiving the video data from the camera, avoiding delay for waiting for entire video to be completed;
determining if there are faces of individuals in each of the frame of the video data, based on a set of matching criteria, including:
shape and size of nose;
shape, size, color, of Eye; and
shape and size of cheek bone;
for each determined face, associating each of the face as a dynamic object;
filtering out all of the dynamic objects in each frame;
applying special effects to highlight the dynamic objects by coloring the dynamic objects in each frame;
applying special effects to grey out static objects, or the non-dynamic objects, by coloring the static objects in each frame;
to compose new video data, re-combining, frame by frame, the dynamic objects with the static objects, after the special effects be applied;
sending the new video data, as video stream, to the mobile device through the wireless network for displaying the new video data;
erasing the received video data, to avoid liability of copyright infringement; and
erasing the sent new video data, to avoid liability of copyright infringement.

11. The system of claim 1, wherein the method comprises:
receiving the video data from the camera;
receiving the photographic image from the camera;
identifying, from each frame of the video, faces of individuals in each of the frame;
determining if a user-defined facial dynamic object is found by comparing, for each frame of the video, the faces of individual in each of the frame against the face represented as the image object captured by the camera, in view of a set of matching criteria, including:
1. Shape and size of nose;
2. Shape, size, color, of Eye; and
3. Shape and size of cheek bone;
filtering out the user-defined facial dynamic objects in each frame;
applying special effects to highlight the user-defined facial dynamic objects by coloring the user-defined facial dynamic objects in each frame;
applying special effects to grey out non-user-defined facial dynamic objects, by coloring the non-user-defined dynamic objects in each frame;
to compose new video data, re-combining, frame by frame, the user-defined facial dynamic objects, the non-user-defined facial dynamic objects, and the static objects, after the special effects be applied;
sending the new video data, as video stream, to the mobile device through the wireless network for displaying the new video data;
erasing the received video data and received image, to avoid liability of copyright infringement; and
erasing the sent new video data, to avoid liability of copyright infringement.

12. The system of claim 1, wherein the method comprises:
receiving the video data from the camera, avoiding delay for waiting for entire video to be completed;
comparing, for all frames of the video, one frame with another frame of the video data, to determine if there are dynamic objects between the two frames, wherein the determination is based on movements of corresponding pixels between the two frames;
filtering out the dynamic object in each frame;
applying special effects by adding a new object to each of the frame, in addition to the dynamic object that is filtered out;
applying special effects to grey out static objects, or the non-dynamic objects, by coloring the static objects in each frame;
to compose new video data, re-combining, frame by frame, the dynamic objects, the new objects, and the static objects, after the special effects be applied;
sending the new video data, as video stream, to the mobile device through the wireless network for displaying the new video data;
erasing the received video data, to avoid liability of copyright infringement; and
erasing the sent new video data, to avoid liability of copyright infringement.

13. The system of claim 1, wherein the method comprises:
receiving the video data from the camera, avoiding delay for waiting for entire video to be completed;
comparing, for all frames of the video, one frame with another frame of the video data, to determine if there are dynamic objects between the two frames, wherein the determination is based on movements of corresponding pixels between the two frames;
filtering out the dynamic objects in each frame;
applying special effects to highlight the dynamic objects by coloring the dynamic objects in each frame;
applying special effects to grey out static objects, or the non-dynamic objects, by coloring the static objects in each frame where the dynamic objects are found, wherein the frames in which no dynamic objects are found no special effects will be applied to the frames;
to compose new video data, re-combining the dynamic objects with the static objects, after the special effects be applied, in frames in which dynamic objects are found, wherein the frames in which no dynamic objects are found no re-combining is required;
receiving a request from the mobile device, where in the request relates to demanding frames containing the dynamic objects only;
to respond to the request, sending the new video data, as video stream, to the mobile device through the wireless network for displaying the new video data, wherein only the frames including the dynamic objects are sent to the mobile device;
receiving another request from the mobile device, where in the request relates to demanding frames containing the static objects only;
to respond to the another request, sending the new video data, as video stream, to the mobile device through the wireless network for displaying the new video data, wherein only the frames including the static objects are sent to the mobile device;
erasing the received video data, to avoid liability of copyright infringement; and
erasing the sent new video data, to avoid liability of copyright infringement.
